(19) United States
(12) Patent Application Publication
(10) Pub. No.: US 2005/0102457 A1
(43) Pub. Date: May 12, 2005

(54) System and method for interrupt processing in a multiple processor system

(75) Inventor: Paul D. Stultz, Round Rock, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 10/706,419

(22) Filed: Nov. 12, 2003

(51) Int. Cl. G06F 13/24

(52) U.S. Cl. 710/260

(57) ABSTRACT

A system and method for processing interrupts in a multiple processor system involves the use of uniquely addressable semaphores, each of which is associated with a processor of the multiple processor system and indicates whether the processor is in interrupt mode.

### CROSS-REFERENCE TO RELATED APPLICATIONS

This application is related to a U.S. patent application titled “System and Method for Exiting From an Interrupt Mode in a Multiple Processor System,” which has U.S. application Ser. No. ______, names Paul D. Stultz as inventor, was filed on the same day as the present application, and is incorporated by reference herein.

### TECHNICAL FIELD

The present disclosure relates generally to the field of computer or information systems, and, more particularly, to a system and method for interrupt processing in a computer or information handling system.

### BACKGROUND

As the value and use of information continues to increase, individuals and businesses continually seek additional ways to process and store information. One option available to users of information is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems, including computer systems, typically include at least one microprocessor, memory, and various input and output devices. The components of a computer system are communicatively coupled together using one or more interconnected buses. As an example, the architecture of a computer system may include a processor that is coupled to a processor bus or host bus. In the case of multiprocessor computer systems, two or more processors may be coupled to the processor bus. A memory controller bridge may be coupled between the processor bus and system memory. In addition, a PCI bridge may be coupled between the processor bus to the PCI bus of the computer system. In some computer systems, the memory controller bridge and the PCI bridge are incorporated into a single device, which is sometimes referred to as the north bridge of the computer system. An expansion bridge, sometimes referred to as a south bridge, couples the PCI bus to an expansion bus, such as the ISA bus. The south bridge also serves as a connection point for USB devices and an IDE bus. The south bridge may also include an interrupt controller.

The processor architecture of a computer system will typically support several types of interrupts. An interrupt is a notification given to the processor that causes the processor to halt the execution of operating code and handle an operating condition that has arisen in the system or in one of the system's external devices. As an example, when a key is pressed on the keyboard, an interrupt is passed to the processor from the peripheral controller. The interrupt causes the processor to momentarily stop its current execution stream and receive data from the peripheral controller. Another type of interrupt is a system management interrupt (SMI). Typically, an SMI is the highest order interrupt that can be issued in a computer system. An SMI is often issued when it is necessary for the processor to handle an error condition in the computer system.

When a system management interrupt is issued to the processor, the processor enters system management mode. In a multiple processor environment, because every processor receives the system management interrupt, each of the processors of the computer system will enter system management mode. Typically, in a multiple processor computer system, each processor of the computer system will enter a system management interrupt mode, even though only one processor of the computer system will be selected to actually handle the processing associated with the system management interrupt. As such, in a multiprocessor system, each processor must have control of the processor bus and access to system memory in order to enter into and exit from the system management interrupt mode. Because each processor typically attempts to enter into and exit from system management interrupt mode at the same time, the processors typically contend for control of the processor bus and access to memory.

In general, the processors of a multiple processor system will enter into system management interrupt mode simultaneously as a unit when the interrupt is asserted. In order to manage the entry into and exit from system management interrupt mode, the processors of the computer system will typically set an indicator bit as an indicator or signal to other processors that the processor is in system management interrupt mode. The indicator bit is known as a semaphore and is typically found in a variable in system memory.

Each processor accesses the semaphore that includes the presence bit on an exclusive or atomic basis to insure that the processor will have exclusive access to the presence variable, or semaphore, during the period that the processor is attempting to set or reset the presence variable. Atomic access to the semaphore insures that another processor in the system will not access the semaphore during the interval that a first processor is attempting to set or reset a bit in the semaphore. In computer systems having an non-uniform memory access architecture (NUMA), access times to memory may vary. As such, for the processors in a computer system having a non-uniform memory access architecture, which have longer access times to memory, it is much more difficult to achieve atomic access to memory, as the processor with shorter access times will generally receive access priority.

Exclusive processor access to memory resources is typically accomplished through the use of a “lock” instruction in software, which results in hardware arbitration for atomic access to the system resource being targeted. In the case of a lock instruction, each component in the access path to the resources is dedicated to the instruction. As such, when a processor attempts to accesses the semaphore through use of a lock instruction, the processor, the front side or local bus, and the north bridge are all dedicated to the completion of the lock instruction, and all cached data or operations in any of these dedicated components are generally flushed or discarded. This results not only in a serious impact to the performance of the interrupt, which must wait for any cached, or posted, operations to complete before it begins, but also affects general system performance, as the data that was cached before the system management interrupt is now discarded and must be retrieved again upon completion of the system management interrupt.

### SUMMARY

In accordance with the present disclosure, a technique for processing an interrupt, including a system management interrupt, in a multiple processor system is disclosed in which a distinct semaphore is associated with each processor of the computer system. The semaphores are uniquely addressable and stored at a memory location in which each of the semaphores are offset from a base memory location according to an offset that is uniquely associated with the semaphore and its associated processor.

One technical advantage of the present disclosure is a computer system that includes uniquely addressable semaphores for each processor of the computer system. The establishment of semaphores for each processor permits each semaphore to be accessed independently of the other semaphores. Because each semaphore can be accessed independently, the semaphores need not be accessed on an exclusive, or atomic, basis. Because a lock instruction or another exclusive access instruction need not be used when accessing a semaphore, system performance is improved, as the degradation of system performance commonly encountered with the use of lock instruction is avoided by maintaining currently cached data and posted operations as well as removing contention for resources during a time when all processors in the system will be assessing the same resource.

Another technical advantage of the present disclosure is that the separation and independent access to the multiple semaphores of the computer system improves the ability of multiple processor systems to enter into and exit from system management mode. Because each processor will attempt to update only its associated semaphore upon the initiation of system management mode, there will be less contention for processor resources as opposed to the use of concatenated presence bits in a single addressable word in memory. In addition, the use of a separate presence variable, or semaphore, for each processors avoids the issues of processor interference common in computer systems having a non-uniform memory access architecture and only a single memory location for the presence bits of the computer system. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of the architecture of a computer system;

FIG. 2 is a flow diagram of a series of steps for entering into and exiting from an interrupt mode; and

FIG. 3 is diagram of a memory location.

### DETAILED DESCRIPTION

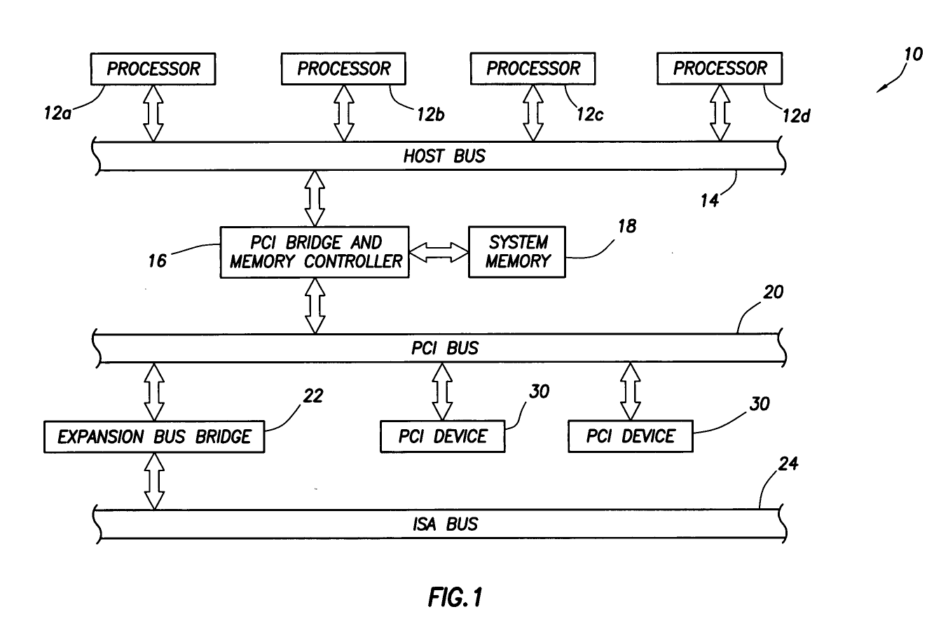

FIG. 1 is a diagram of the architecture of a computer system, which is indicated generally at 10. Computer system 10 is a multiple processor system and includes four processors, identified as processor 12a, processor 12b, processor 12c, and processor 12d. Each of the processors is coupled to a processor or host bus 14. Coupled to processor bus 14 is a PCI bridge and memory controller 16, which is sometimes referred to as a north bridge. System memory 18 is coupled to north bridge 16. North bridge 16 serves as a communications bridge between the host bus 14 and PCI bus 20. In the computer architecture of FIG. 1, PCI devices 30 are coupled to PCI bus 20. In the computer system 10 of FIG. 1, an expansion bus bridge 22 couples PCI bus 20 to an ISA bus 24. As just one alternative to the computer architecture shown in FIG. 1, expansion bus 22 could be coupled to a Super I/O device (not shown). Expansion bus bridge 22§ is sometimes referred to as a south bridge.

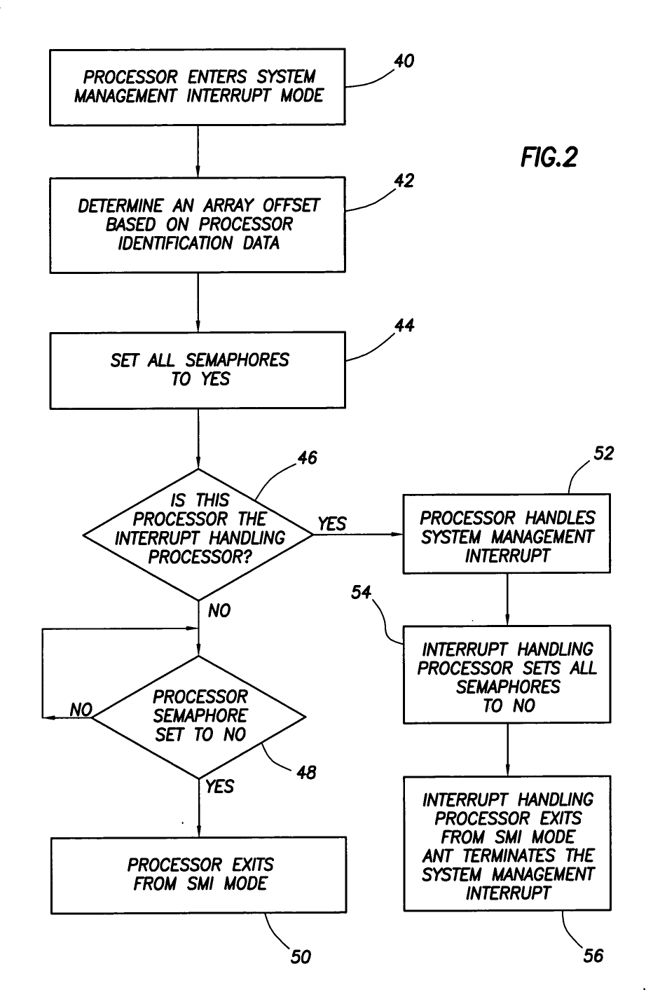

FIG. 2 is a diagram of a series of steps for entering and exiting from system management mode without the necessity of having each processor executive a lock instruction or possess exclusive access to system resources. Before entering the steps shown in FIG. 2, the processors of the computer system are uniquely identified. This identification step may occur during power-on self test (POST) or during the execution of the BIOS commands. In this disclosure, it is presumed that each processor is uniquely identified and then associated with a series of consecutive integers beginning with 1. In the present disclosure, the processors will be referred to as Processor No. 1 (processor 12a of FIG. 1), Processor, No. 2 (processor 12b), Processor No. 3 (processor 12c), and Processors No. 4 (processor 12d).

Shown in FIG. 2 is a flow diagram for a method for entering into system management interrupt mode, processing a system management interrupt, and returning from system management interrupt mode in a computer system or information handling system. With reference to the computer system 10 of FIG. 1, when a system management interrupt is issued, each of the four processors of the multiple processor computer system will enter system management interrupt mode. In system management interrupt mode, each of the processors will save the contents of its registers to the memory space associated with that processor or SMRAM. Each processor will then execute a series of software instructions. The instructions executed by each processor will vary according to whether the processor at issue, which is sometimes referred to as the subject processor, is selected to handle the processing task associated with the system management interrupt. The processor selected to handle the processing tasks associated with resolving the interrupt is known as the interrupt handling processor. A processor not selected for the resolution of the interrupt is often referred to as a non-interrupt handling processor.

The steps of the flow diagram of FIG. 2 are applied to or performed by each processor, regardless of whether the processor is the interrupt handling processor or the non-interrupt handling processor. At step 40, each processor, whether the interrupt handling processor of the non-interrupt handling processor, enters system management interrupt mode. At step 42, an array offset is determined for each previously identified processor of the computer system. The purpose of the array offset is to determine the offset that will be added to a base memory location to identify a memory location for the storage of a presence variable, or semaphore, associated with each processor of the computer system. As an example, the offset could be positive multiples of four. Thus, for each of the processors of the example computer system, the offset is:

| Processor ID | Offset |
|---|---|
| 1 | 4 |
| 2 | 8 |
| 3 | 12 |
| 4 | 16 |

In accordance with the above example, the semaphore associated with Processor No. 1 is four memory locations or memory addresses distant from a base memory location; the semaphore associated with Processor No. 4 is sixteen memory locations or memory addresses distant from a base memory location. The memory locations for the semaphores may be included in SMRAM.

At step 44, the semaphores associated with each processor are set to a positive indicator or a logical YES. In one embodiment, the semaphore is a single word in memory. The semaphore indicates whether the associated processor is in system management interrupt mode. It should be recognized that the semaphore may also be a bit, flag, or other indicator in the computer system that is associated with one of several processors and is separately stored in memory as provided in the present disclosure. A processor's semaphore may be read or reset by any other processor. Following the entry of the processors into system management mode, the interrupt handling processor is selected according to an arbitration process. At step 44, each processor is interrogated to determine if the subject processor was selected as the interrupt handling processor. If the interrogated or subject processor is the interrupt handling processor, the flow diagram continues with step 52; otherwise, the flow diagram continues at step 48.

At step 48 it is determined if the semaphore associated with the subject non interrupt handling processor has been set to a negative indicator or a logical NO. If the presence bit for the subject processor has not been set to a negative indicator or logical NO, the processor performs a loop operation through step 48 until it is determined that the presence bit for the processor has been set to a negative indicator or a logical NO. When this occurs, the subject processor exits system management interrupt mode at step 50. Thus, for the non-interrupt handling processors of the computer system, the processor waits until its presence bit is set to a negative indicator or a logical NO, following which the subject processor exits system management interrupt mode.

With reference to step 52 and the operations of the interrupt handling processor, the flow diagram of FIG. 2 continues at step 52 following a determination that the subject processor is the interrupt handling processor. At step 52, the interrupt handling processor performs the processing tasks associated with the system management interrupt. At step 54, following the completion of the processing tasks necessary to clear the system management interrupt, the interrupt handling processor sets the semaphores associated with each of the processors to a negative indicator or a logical NO. The processor of setting each semaphore to a negative indicator or a logical NO may be performed on a serial or time-delayed basis. Once the semaphore of a non-interrupt handling processor is set to a logical NO, the non-interrupt handling processors eventually exit from system management interrupt mode through steps 48 and 50.

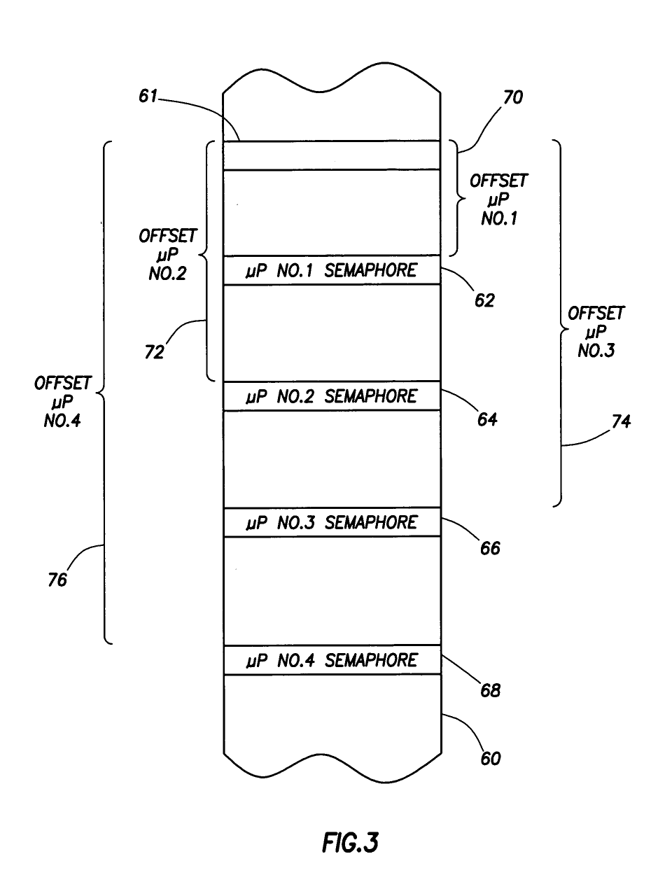

Shown in FIG. 3 is a diagram of a memory location 60. The location of the semaphore for Processor No. 1 is shown at 62, and is indicated as being an offset 70 distant from a base memory location 61. The location of the semaphore for Processor No. 2 is shown at 64 and is shown as having an offset 72 from a base memory location 61. Similarly, the locations of the semaphores associated with Processor No. 3 and Processor No. 4 are shown at 66 and 68, respectively. The semaphores for Processor No. 3 and Processor No. 4 are shown as having offsets 74 and 76, respectively, from base memory location 61.

The system management interrupt processing technique disclosed herein provides for separate semaphores for each processor of the computer system. The semaphores are offset from one another in memory locations in a memory location in the computer system. Because a separate and distinct semaphore is assigned to each processor, the access by a processor to its associated semaphore can be accomplished on a non-exclusive basis without the necessity of a lock instruction and without the risk of interference caused by another processor having a shorter access time in a non-uniform access architecture computer system.

It should be recognized that any suitable scheme may be used to identify the processors of the computer system so long as the scheme provides a basis for applying a memory offset to each of the identified processors. It should also be recognized that the technique described herein is not limited to the computer architecture shown in FIG. 1. Rather, the techniques described herein may be applied in any multiple processor computer or information handling system when there is contention for resources upon the entry into or the exit from a system interrupt event that influences all the processor resources of the computer system. Although the present disclosure has been described in detail, it should be understood that various changes, substitutions, and alterations can be made hereto without departing from the spirit and the scope of the invention as defined by the appended claims.

1. An information handling system, comprising:
a plurality of processors coupled to a processor bus; and
a memory;
wherein each of the processors is operable to enter an interrupt mode and wherein a uniquely addressable semaphore in memory is associated with each processor and indicates whether the associated processor is in interrupt mode.

2. The information handling system of claim 1, wherein each of the semaphores is stored in a memory location that is offset from a base memory location by a unique offset indicator.

3. The information handling system of claim 1, wherein each processor is operable to access the semaphore associated with the other processors of the information handling system.

4. The information handling system of claim 1, wherein each processor is operable to access the semaphores associated with the processors of the information handling system on a non-exclusive basis.

5. The information handling system of claim 1, wherein the memory location associated with the storage of the semaphores associated with the processors of the information handling system is memory space dedicated to storing data associated with the entry of the processors into interrupt mode.

6. The information handling system of claim 1, wherein the interrupt mode is system management interrupt mode.

7. The information handling system of claim 1,
wherein the interrupt mode is system management interrupt mode;
wherein the semaphore associated with a processor is stored in a memory location that is offset from a base memory location by a unique offset indicator associated with the processor; and
wherein each processor is operable to access the semaphore associated with the other processors of the information handling system on a non-exclusive basis.

8. A method for processing an interrupt in a multiple processor computer system, comprising the steps of:
for each processor, entering interrupt mode;
for each processor, setting a semaphore associated with the processor to indicate that the processor is in interrupt mode, wherein a uniquely addressable semaphore is associated with each processor;
for the interrupt handling processor, performing the tasks necessary to resolve the interrupt and negating the semaphore associated with the non-interrupt handling processors of the computer system; and
for each non-interrupt handling processors, exiting interrupt mode up following the negation of the semaphore associated with the processor.

9. The method for processing an interrupt in a multiple processor computer system of claim 8, wherein the step of setting a semaphore for each processor comprises the step of setting the semaphore for each processor on a non-exclusive basis.

10. The method for processing an interrupt in a multiple processor computer system of claim 8, wherein the step of negating the semaphores of the non-interrupt handling processors of the computer system comprises the step of negating the semaphores of the non-interrupt handling processors of the computer system on a non-exclusive basis.

11. The method for processing an interrupt in a multiple processor computer system of claim 8, wherein the interrupt is a system management interrupt.

12. The method for processing an interrupt in a multiple processor computer system of claim 8, wherein each of the semaphores are stored in a memory location that is offset from a base memory location by a unique offset indicator.

13. The method for processing an interrupt in a multiple processor computer system of claim 8,
wherein the step of setting a semaphore for each processor comprises the step of setting the semaphore for each processor on a non-exclusive basis;
wherein the step of negating the semaphores of the non-interrupt handling processors of the computer system comprises the step of negating the semaphores of the non-interrupt handling processors of the computer system on a non-exclusive basis; and
wherein each of the semaphores are stored in a memory location that is offset from a base memory location by a unique offset indicator.

14. The method for processing an interrupt in a multiple processor computer system of claim 8,
wherein the interrupt is a system management interrupt;
wherein the step of setting a semaphore for each processor comprises the step of setting the semaphore for each processor on a non-exclusive basis;
wherein the step of negating the semaphores of the non-interrupt handling processors of the computer system comprises the step of negating the semaphores of the non-interrupt handling processors of the computer system on a non-exclusive basis; and
wherein each of the semaphores is stored in a memory location that is offset from a base memory location by a unique offset indicator.

15. A computer system, comprising:
a plurality of processors;
a memory;
wherein the architecture of the processors and the memory is a non-uniform memory access architecture; and
wherein each of the processors is operable to enter an interrupt mode and wherein a uniquely addressable semaphore in memory is associated with each processor and indicates whether the associated processor is in interrupt mode.

16. The computer system of claim 15, wherein the interrupt mode is associated with a system management interrupt.

17. The computer system of claim 16, wherein each of the semaphores is stored in a memory location that is offset from a base memory location by a unique offset indicator.

18. The computer system of claim 17, wherein the memory location associated with the storage of the semaphores is memory space dedicated to storing data associated with the entry of the processors into interrupt mode.

19. The computer system of claim 16, wherein the semaphores may be accessed by each of the processors on a non-exclusive basis.

20. The computer system of claim 16,
wherein the semaphores may be accessed by each of the processors on a non-exclusive basis; and
wherein each of the semaphores is stored in a memory location that is offset from a base memory location by a unique offset indicator.
